(19) United States
(12) Patent Application Publication
(10) Pub. No.: US 2021/0142328 A1
(43) Pub. Date: May 13, 2021

(54) SYSTEM AND METHOD FOR PREVENTING FRAUD IN REAL-TIME PAYMENT TRANSACTIONS

(71) Applicant: Early Warning Services, LLC, Scottsdale, AZ (US)

(72) Inventors: Joseph Sean Sylvester, Phoenix, AZ (US); Laura Weinflash, Scottsdale, AZ (US); Chad Lowe, Mesa, AZ (US); Michael Feliciano, Scottsdale, AZ (US); Chuck Hutchison, Phoenix, AZ (US)

(73) Assignee: Early Warning Services, LLC, Scottsdale, AZ (US)

(21) Appl. No.: 16/682,489

(22) Filed: Nov. 13, 2019

(51) Int. Cl. G06Q 20/40; G06Q 20/38; G06Q 20/26

(52) U.S. Cl. CPC G06Q 20/4016; G06Q 20/26; G06Q 20/407; G06Q 20/3829

(57) ABSTRACT

A system including one or more processors and one or more non-transitory computer-readable media storing computing instructions configured to run on the one or more processors and perform various acts. The acts can include receiving, in real-time and through a computer network, a payment authorization from a first financial institution. The payment authorization can comprise a payment amount, a recipient account indicator, and a fund withholding instruction for the payment amount and associated with a release condition for the payment amount. The acts also can include after receiving the payment authorization, instructing, through the computer network, a fund withholding financial institution to post the payment amount to a fund withholding account maintained by the fund withholding financial institution. The acts further can include receiving, through the computer network and from the fist financial institution, a release decision that is based on the release condition. When the release decision is to release the payment amount to the recipient, the acts also can include (a) instructing, through the computer network, the fund withholding financial institution to debit in real-time the payment amount from the fund withholding account after receiving the release decision, and (b) instructing, through the computer network, the second financial institution to post in real-time the payment amount to the recipient account after the payment amount is debited from the fund withholding account. Other embodiments are provided.

### TECHNICAL FIELD

This disclosure relates generally to financial transaction processing, and relates more particularly to secure real-time payment transactions and networks.

### BACKGROUND

In a real-time payment transaction, a buyer authorizes a financial institution to debit a payment amount from the account of the buyer and transfers the payment amount in real-time to a seller before, or at the same time when, the seller delivers a product, such as a concert ticket or an electronic gift card. If the seller fails to deliver the product or the product is later found to be a counterfeit or defective, because the payment transaction was completed in real-time, the buyer has lost the payment amount, which may or may not be able to be recovered if the buyer attempts goes through the trouble of apply for a refund, such as contacting the seller or providing proof to an intermediary to dispute the transaction. As such, online buyers are sometimes reluctant to use real-time payments, in particular when they do not have prior successful dealings with a seller.

### BRIEF DESCRIPTION OF THE DRAWINGS

To facilitate further description of the embodiments, the following drawings are provided in which:

FIG. 1 illustrates a block diagram of a system that can be employed for preventing fraud in real-time payment transactions, according to an embodiment;

FIG. 2 illustrates a flow chart for a method for preventing fraud in real-time payment transactions, according to an embodiment;

FIG. 3 illustrates a flow chart for a method for preventing fraud in real-time payment transactions, according to another embodiment;

FIG. 4 illustrates a flow chart for a method for preventing fraud in real-time payment transactions, according to yet another embodiment;

FIG. 5 illustrates a computer that is suitable for implementing an embodiment of components of the system of FIG. 1; and

FIG. 6 illustrates a representative block diagram of an example of elements included in circuit boards inside a chassis of the computer of FIG. 5.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, or five minutes.

### DESCRIPTION OF EXAMPLES OF EMBODIMENTS

Various embodiments include a system comprising one or more processors and one or more non-transitory computer-readable media storing computing instructions configured to run on the one or more processors and perform certain acts to prevent fraud in, and enhance the security of, real-time payment transactions. The acts can include: (a) receiving, in real-time and through a computer network, a payment authorization from a first financial institution; (b) after receiving the payment authorization, instructing, through the computer network, a fund withholding financial institution to post in real-time a payment amount to a fund withholding account maintained by the fund withholding financial institution in real-time; (c) receiving, through the computer network and from the first financial institution, a release decision; and (d) when the release decision is to release the payment amount to the recipient, (i) instructing, through the computer network, the fund withholding financial institution to debit in real-time the payment amount from the fund withholding account after receiving the release decision, and (ii) instructing, through the computer network, a second financial institution to post in real-time the payment amount to a recipient account after the payment amount is debited from the fund withholding account.

In many embodiments, the system can be different from the first financial institution, the fund withholding financial institution, and the second financial institution and the system can be configured to facilitate real-time payment transactions between financial institutions. The payment authorization can be generated by the first financial institution based on a payment instruction by or from a user (i.e., the sender). The payment authorization from the first financial institution can include one or more of the payment amount provided by the sender, a recipient account indicator, and/or a fund withholding instruction that is for the payment amount and that is associated with a release condition, etc. In some embodiments, the recipient account indicator is the actual account number at a second financial institution for the recipient that is to receive the payment amount. In other embodiments, the recipient account indicator is an identifier or a key of the recipient, but not the recipient account (i.e., not the recipient account number). In these other embodiments, the identifier or key of the recipient can include any information sufficient for the system to uniquely identify the account or account number of the recipient maintained at a second financial institution for receiving the payment amount. For instance, the identifier or key of the recipient can be a public key such as a phone number, an email, a user identifier, a machine-readable code, and so on.

Before transmitting the payment authorization to the system, the first financial institution can verify with the system whether the key of the recipient can be linked to a valid recipient account, including a second financial institution associated with the recipient account, and obtain the recipient account from the system to add to the payment authorization. The first financial institution also can verify the identity of the sender by one or more suitable conventional digital authentication techniques, such as verifying predefined passwords, biometrics, at least one preregistered computing device being associated with the sender (the “sender device”), one-time passwords, or a combination thereof.

The payment authorization can further involve a promise-to-pay message by the first financial institution after successful sender account verification for the payment amount. The first financial institution can verify that the sender has an account, such as a checking account or a saving account, with sufficient fund at the first financial institution, before submitting the payment authorization to the system. In addition, the first financial institution can be configured to debit the sender account maintained by the first financial institution for the payment amount, plus any applicable fees, before transmitting the payment authorization. In many embodiments, a successful debit of the sender account by the first financial institution can be part of the successful sender account verification. Furthermore, the first financial institution also can perform one or more of fraud prevention acts, including checking the transaction history of the sender account to see whether there are one or more outstanding disputes or claims against the sender account, whether there is a potential overdraw of the sender account in view of the outstanding disputes or claims and the payment amount, or whether the account of the sender is associated with known or potential bank crimes, etc. The successful sender account verification can thus further include at least one of: a lack of one or more outstanding disputes or claims against the sender account, a lack of a potential overdraw of the sender account (wherein the potential overdraw exists when a combined value of (a) the one or more outstanding disputes or claims and (b) the payment amount is greater than a balance of the sender account), or a low risk of bank crimes associated with the sender account.

In some transactions, the sender and the recipient can agree, after negotiation through the computer network via one or more user interfaces executed on their respective computing devices (i.e., the sender device and the recipient device), to withhold the payment amount until the release condition is satisfied. The release condition can be communicated through the computer network to the system after: (a) the release condition is accepted by the sender and the recipient via the user interfaces executed on the sender device and the recipient device respectively, and (b) a transaction associated with the recipient is initiated by the sender via the user interfaces executed on the sender device. In some exemplary systems, the sender can transmit the release condition and relevant information, via the sender device through the computer network, to the first financial institution for incorporating such information into the payment authorization to be communicated to the system. Alternatively, the one or more user interfaces for negotiating and setting the release condition can be provided by the system, and the release condition and any information related to the release condition can thus be communicated to the system through the computer network directly by the sender via the sender device or by the recipient via the recipient device, with or without notifying the first financial institution.

In a number of embodiments, the release condition can comprise at least one of: (a) a predefined period of time has elapsed after the payment authorization is sent by the first financial institution or is received by the system; (b) a predefined point in time has passed; or (c) a fund release instruction is received from a sender device. Examples of the agreed-upon release condition can include that a predefined period of time, such as 15 minutes, 2 hours, a day, or 3 days, has elapsed after the sender instructs the first financial institution to send the payment authorization, or after the first financial institution sends the payment authorization to the system, or after the system confirms the receipt of the payment authorization from the first financial institution. Another example of the release condition can be when a predefined point in time, such as 12 pm the following day or a time associated with a product purchased at this transaction, has passed. The product in this example can be a ticket for a basketball game at 6 pm the coming Friday, for instance, and the predefined point in time can thus be the time the game begins, the time the arena entrances open, or 30 minutes before the game begins. Yet another example of the release condition can be 5 pm of the coming Thursday or when a fund release instruction is received from the sender device, whichever comes first.

In many embodiments, the system can receive the releasing decision from the first financial institution. In some embodiments, the first financial institution can determine the release decision based on the release condition. In several embodiments, the first financial institution can send the release decision to the system in real-time when the first financial institution receives a satisfaction notice from the sender via the sender device.

Once the system receives the payment authorization, it can be further configured to compile a disperse authorization in real-time, based on the payment authorization. An exemplary disperse authorization can comprise the key or account associated with the sender, the key or account associated with the recipient, an identification of the first financial institution, the payment amount, and/or the fund withholding instruction comprising the release condition. The system can then transmit the disperse authorization to the fund withholding financial institution to post the payment amount to the fund withholding account for temporarily withholding such payment amount specified in the disperse authorization. In some embodiments, the disperse authorization is identical to the payment authorization.

The fund withholding account can be different from the recipient account that is associated with the recipient account indicator and the recipient. The fund withholding account can be maintained by the fund withholding financial institution, while the recipient account can be maintained by the second financial institution that is different from the fund withholding financial institution. In several different embodiments, the fund withholding account can instead be maintained by the second financial institution that maintains the recipient account while the fund withholding account remains separate from the recipient account. In certain embodiments, the second financial institution can comprise the fund withholding financial institution. While it is posted to the fund withholding account, the payment amount can be inaccessible to the recipient (regardless of whether the fund withholding account is maintained by the same financial institution or a different financial institution that maintains the recipient account) until the payment amount is transferred to the recipient account after the release condition is satisfied.

The acts also can include the system receiving the release decision about whether the release condition specified in the payment authorization is satisfied. The release decision can include an instruction to release (or not release) the payment amount to the recipient. Whether the release condition is satisfied can be determined by a release condition determiner, selected from one of the first financial institution, the fund withholding financial institution, or the second financial institution, that is configured to send, to the system through the computer network, a release notice that the release condition is satisfied.

Depending on the terms in the release condition agreed upon by the sender and the recipient, the release condition determiner can be configured to transmit the release notice to the system in real-time when the sender authorizes the release by a satisfaction notice to the release condition determiner via the sender device. When the release condition concerns a predefined time, such as an elapsed period of time or a specific point in time, to release the payment amount, the release condition determiner can set a timer based on the a predefined time so that the when the timer expires, the release decision is automatically set as “to release,” and the release condition determiner can then proceed to send the release decision to the system. In some embodiments, instead of passively waiting for a notice from the release condition determiner, the system can wait for a predetermined waiting period, such as an hour, two hours, or a day, etc., and then repeat a process of requesting an update about the release decision from the release condition determiner.

When the release decision is to release the payment amount to the recipient, the acts can additionally include transferring the payment amount into the recipient account by (a) the system instructing, through the computer network, the fund withholding financial institution to debit in real-time the payment amount from the fund withholding account after receiving the release decision; and (b) the system instructing, through the computer network, the second financial institution to post in real-time the payment amount to the recipient account after the payment amount is debited from the fund withholding account. After the payment amount is posted to the recipient account, and thus accessible to the recipient, the acts can further include sending a payment confirmation through the computer network to the first financial institution by the system and/or to the recipient by the second financial institution, in real-time.

Finally, posting the payment amount to the fund withholding account by the second financial institution can occur before, after, or concurrently with a fund settlement of the payment amount between the first financial institution and the fund withholding financial institution. The fund settlement can involve transferring the payment amount debited from the sender account maintained by the first financial institution to the fund withholding account maintained by the fund withholding financial institution, either directly between the two financial institutions or through a fund settling entity, such as an Automated Clearing House (ACH), a wire transfer network, a credit/debit card network, etc. When the fund settling entity is used, the fund settling entity can be configured to receive the disperse authorization from the system, forward in real-time the disperse authorization to the fund withholding financial institution after receiving the disperse authorization, and/or facilitate the fund settlement of the payment amount between the first financial institution and the fund withholding financial institution. In some embodiments, the fund withholding financial institution can be included in the second financial institution. For instance, the fund withholding financial institution can operate as a system or module separate from, and interfacing with, a user account management system of the second financial institution.

Turning to the drawings, FIG. 1 illustrates a block diagram of a system 100 that can be employed for a real-time payment transaction network, according to an embodiment. System 100 is merely exemplary, and embodiments of the system are not limited to the embodiments presented herein. System 100 can be employed in many different embodiments or examples not specifically depicted or described herein. In some embodiments, certain elements, modules, subsystems, or systems of system 100 can perform various procedures, processes, and/or activities. In other embodiments, the procedures, processes, and/or activities can be performed by other suitable elements, modules, subsystems, or systems of system 100.

In some embodiments, system 100 can include one or more systems, such as a system 110, one or more fund withholding financial institutions, such as a fund withholding financial institution 120, at least two financial institutions, such as a first financial institution 130 and a second financial institution 150, a plurality of accounts, such as a sender account 131, a fund withholding account 121, and/or a recipient account 151, one or more user computing devices, such as a sender device 162 of a sender 161 and a recipient device 164 of a recipient 163, and/or one or more fund settling entities, such as a fund settling entity 170. In a number of embodiments, system 110 can include one or more modules, subsystems, and/or systems. In some embodiments, system 100 can include a fund withholding & second financial institution 180 that comprises fund withholding financial institution 120, second financial institution 150, fund withholding account 121, and/or recipient account 151. In other embodiments, second financial institution 150 can comprise fund withholding financial institution 120.

In a number of embodiments, system 110 can be configured to perform one or more of the following acts: (a) receiving, in real-time and through a computer network, such as network 140, a payment authorization from first financial institution 130; (b) after receiving the payment authorization, instructing, through network 140, fund withholding financial institution 120 to post in real-time a payment amount to fund withholding account 121 maintained by fund withholding financial institution 120; (c) receiving, through network 140 and from first financial institution 130, a release decision; and (d) when the release decision is to release the payment amount to the recipient, (i) instructing, through network 140, fund withholding financial institution 120 to debit in real-time the payment amount from fund withholding account 121 after receiving the release decision, and (ii) instructing, through network 140, second financial institution 150 to post in real-time the payment amount to recipient account 151 after the payment amount is debited from fund withholding account 121.

In a number of embodiments, the payment authorization can comprise a payment amount, a recipient account indicator, and/or a fund withholding instruction that is for the payment amount and that is associated with a release condition. In some embodiments, the payment authorization also can comprise one or more of a sender account indicator, or a sender account, etc. In some embodiments, the recipient account indicator is the actual account number of recipient account 151 at second financial institution 150 for recipient 163 that is to receive the payment amount. In other embodiments, the recipient account indicator is an identifier or a key of recipient 163, but not recipient account 151 (i.e., not the recipient account number). In these other embodiments, the identifier or key of recipient 163 can include any information sufficient for system 110 to uniquely identify recipient account 151 (i.e., the account number of recipient account 151) maintained at second financial institution 150 for receiving the payment amount. For instance, the identifier or key of the recipient can be a public key such as a phone number, an email, a user identifier, a machine-readable code, and so on.

In a number of embodiments, system 110 can be configured to receive, through network 140 and from first financial institution 130, a release decision to release in real-time the withheld fund (i.e., the payment amount posted in fund withholding account 121), after the release condition is satisfied. In some embodiments, system 110 can be configured to instruct, through network 140, fund withholding financial institution 120 to post in real-time the payment amount to fund withholding account 121 maintained by fund withholding financial institution 120, before, after, or concurrently with a fund settlement of the payment amount between first financial institution 130 and fund withholding financial institution 120. In many embodiments, system 110 is different from fund withholding financial institution 120, first financial institution 130, second financial institution 150, and fund settling entity 170.

In several embodiments, a single one of the modules, subsystems, or systems in system 110, can be configured to perform all the aforementioned act(s) performed by system 110. In a number of embodiments, a plurality of modules, subsystems, and/or systems in system 110 can be configured to work with each other to perform one or more acts for preventing fraud in real-time payment transactions.

Still referring to FIG. 1, in many embodiments, system 110 can be a financial institution, an inter-financial-institution payment network, a third-party real-time payment processor, etc. In a number of embodiments, system 110 can be configured to store public keys of account holders, such as sender 161 and/or recipient 163, and information of their corresponding accounts at financial institutions, such as account numbers of sender account 131 and/or recipient account 152, and coordinate with the financial institutions, such as first financial institution 130 and/or second financial institution 150, and/or one or more fund settling entities, such as fund settling entity 170, to facilitate real-time payment transactions between the account holders, such as sender 161 and recipient 163. In many embodiments, the matching between a public key of an account holder and its corresponding account number at a financial institution can be unique. Examples of a public key of an account holder can include an email address, a phone number, a machine readable code, and so forth.

In a number of embodiments, system 110 further can be configured to determine recipient account 151 (i.e., the account number of recipient 163) from the payment authorization based on the recipient account indicator being a recipient public key received from first financial institution 130. In some embodiments, second financial institution 150 can be configured to store the public keys of local account holders, such as recipient 163, and information regarding the corresponding accounts that second financial institution 150 maintains, such as recipient account 151. In similar and other embodiments, the payment authorization can comprise either the recipient account indicator or recipient account 151, or both.

In some embodiments, system 110 can be configured to compile and submit, in real-time and through network 140, the disperse authorization to fund withholding financial institution 120, after system 110 receives the payment authorization from first financial institution 130. In a number of embodiments, the release condition can comprise at least one of: (a) a predefined period of time has elapsed after the payment authorization is sent by first financial institution 130 or is received by system 100; (b) a predefined point in time has passed; or (c) a fund release instruction is received from sender device 162, etc.

In many embodiments, the at least two financial institutions, such as first financial institution 130 and second financial institution 150, can be configured to act as intermediaries for financial and monetary transactions including deposits and/or money transfers and maintain accounts for their customers, such as sender 161 and recipient 163, to engage in such transactions. Examples of financial institutions can include banks or credit unions. In a number of embodiments, the payment authorization from first financial institution 130 involves a promise-to-pay message by first financial institution 130 after successful sender account verification for the payment amount. In some embodiments, the successful sender account verification can include verifying that the balance of sender account 131 exceeds the payment amount, plus any required fees for this payment transaction, and/or successfully debiting sender account 131 maintained by first financial institution 130 for the payment amount, plus fees if any. In some embodiments, the successful sender account verification also can comprise at least one of: (a) a lack of one or more outstanding disputes or claims against sender account 131; (b) a lack of a potential overdraw of sender account 131, wherein the potential overdraw exists when a combined value of (i) the one or more outstanding disputes or claims and (ii) the payment amount is greater than the balance of sender account 131; or (c) a low risk of bank crimes associated with sender account 131. Exemplary indication of a potentially high risk of bank crimes associated with an account can include a newly opened account or an account associated with one or more suspicious activities, such as frequent transactions, low balances, claims of fraud, recent or frequent personal identifying information changes, etc. Exemplary indication of a potentially low risk of bank crimes associated with an account can include a long-standing account, an account lacking suspicious activities (such as the suspicious activities identified above), an account with infrequent transactions, an account with high balances, an account without a history of fraud, an account with infrequent personal identifying information changes, etc.

In a number of embodiments, the release condition can be negotiated by sender 161 and recipient 163 through network 140 via user interfaces executed on sender device 1621 and recipient device 164 respectively. In some embodiments, the release condition can be communicated, through network 140, by at least one of sender 161, recipient 163, or first financial institution 130 to system 110 after: (a) the release condition is accepted by sender 161 and recipient 163 via the user interfaces executed on sender device 162 and recipient device 164 respectively, and (b) a transaction associated with recipient 163 is initiated by sender 161 via the user interfaces executed on sender device 162. In similar or other embodiments, sender 161 can initiate the transaction voluntarily or upon receiving, through network 140, a request of payment from recipient 163 via recipient device 164.

Further, in many embodiments, the one or more fund settling entities, such as fund settling entity 170, can be configured to perform the fund settlement involving transferring the payment amount debited from sender account 131 maintained by first financial institution 130 to fund withholding account 121 maintained by fund withholding financial institution 120. In some embodiments, the disperse authorization received through network 140 from system 110 is forwarded in real-time by fund settling entity 170 to fund withholding financial institution 120 after fund settling entity 170 receives the disperse authorization from system 110, and fund settling entity 170 is further configured to facilitate the fund settlement of the payment amount between first financial institution 130 and fund withholding financial institution 120. Examples of fund settling entity 170 can include an Automated Clearing House (ACH), a wire transfer network, a credit/debit card network, etc.

In a number of embodiments, each of the one or more systems, the one or more first entities, the at least two financial institution, the one or more user computing devices, and the one or more fund settling entities can be or include a computer system, such as computer system 500, as shown in FIG. 5 and described below, and can be a single computer, a single server, or a cluster or collection of computers or servers, or a cloud of computers or servers. In many embodiments, various components (e.g., 110, 120, 130, 150, 162, 164, 170, and/or 180) of system 100 can be in data communication with various other components (e.g., 110, 120, 130, 150, 162, 164, 170, and/or 180) of system 100, such as through one or more networks (e.g., network 140). The computer networks can be the Internet and/or other suitable data communication networks.

In various embodiments, system 110 can be a computer system comprising one or more processors and one or more non-transitory computer-readable media storing computing instructions configured to run on the one or more processors and perform one or more acts for preventing fraud in real-time payment transactions between one or more senders, such as sender 161, and one or more recipients, such as recipient 163, similar to the various acts in previous examples. In some embodiments, sender 161 can be a buyer of a product offered for sale by a seller (e.g., recipient 163) or a customer for a service to be provided by recipient 163.

In some embodiments, certain elements, modules, subsystems, or systems of system 110, can perform various procedures, processes, and/or activities. In other embodiments, the procedures, processes, and/or activities can be performed by other suitable elements, modules, subsystems, or systems of system 100 and/or system 110. In many embodiments, the elements, modules, subsystems, or systems of system 100 and/or system 110 each can be implemented by a various number of suitable software components, hardware components, or combinations thereof. Examples of the elements, modules, subsystems, or systems of system 100 and/or system 110 can include a processing system configured to execute computing instructions, a network system configured to transmit and receive data to or from network 140, an external service system configured to interface with one or more external services, computers, or servers, such as fund withholding financial institution 120, first financial institution 130, sender device 162, recipient device 164, and/or second financial institution 150, and so forth. In some embodiments, the elements, modules, subsystems, or systems of system 100 and/or system 110 each can comprise one or more subsystems. For example, a single system of system 100 and/or system 110 can comprise a processing subsystem and a network subsystem.

Turning ahead in the drawings, FIG. 2 illustrates a flow chart for a method 200, according to an embodiment. In some embodiments, method 200 can be a method of facilitating fraud preventions in real-time payment transactions. Method 200 is merely exemplary and is not limited to the embodiments presented herein. Method 200 can be employed in many different embodiments or examples not specifically depicted or described herein. In some embodiments, the procedures, the processes, and/or the activities of method 200 can be performed in the order presented. In other embodiments, the procedures, the processes, and/or the activities of method 200 can be performed in any suitable order. In still other embodiments, one or more of the procedures, the processes, and/or the activities of method 200 can be combined or skipped. In some embodiments, method 200 can be performed by system 100 and/or system 110 (FIG. 1).

Referring to FIG. 2, in some embodiments, method 200 can optionally include one or more blocks. Specifically, method 200 can include block 210 of a system receiving, through a computer network, a payment authorization from a first financial institution. The system can be similar or identical to system 100 and/or system 110 (FIG. 1). The computer network can be similar or identical to network 140 (FIG. 1). The first financial institution can be similar or identical to first financial institution 130 (FIG. 1). The system can be different from the first financial institution.

In several embodiments, the payment authorization can comprise at least one of: a payment amount, a recipient account indicator (i.e., an identifier or public key of the recipient), a recipient account (i.e., an account number of the recipient), or a fund withholding instruction for the payment amount and associated with a release condition for the payment amount. In some embodiments, the recipient account can be associated with the recipient account indicator and the recipient and be maintained by a second financial institution that is different from the system and the first financial institution. The recipient account can be similar or identical to recipient account 151 (FIG. 1). The second financial institution can be similar or identical to second financial institution 150 (FIG. 1). The release condition can comprise at least one of: (a) a predefined period of time has elapsed after the payment authorization is sent from the first financial institution or is received by the system, (b) a predefined point in time has passed, or (c) a fund release instruction is received from a sender device. The sender device can be similar or identical to sender device 162 (FIG. 1).

In many embodiments, the payment authorization from the first financial institution in block 210 further can involve a promise-to-pay message by the first financial institution after successful sender account verification for the payment amount. The sender account can be similar or identical to sender account 131 (FIG. 1). In a number of embodiments, the successful sender account verification can comprise a confirmation that the first financial institution successfully debits the payment amount from the sender account. In several embodiments, the successful sender account verification also can comprises at least one of: (a) a lack of one or more outstanding disputes or claims against the sender account, (b) a lack of a potential overdraw of the sender account, wherein the potential overdraw exists when a combined value of (i) the one or more outstanding disputes or claims and (ii) the payment amount is greater than a balance of the sender account, or (c) a low risk of bank crimes associated with the sender account.

In a number of embodiments, the release condition in block 210 can be negotiated by a sender and a recipient through the computer network via user interfaces executed on a sender device and a recipient device respectively. The sender can be similar or identical to sender 161 (FIG. 1). The recipient can be similar or identical to recipient 163 (FIG. 1). The sender device can be similar or identical to sender device 162 (FIG. 1). The recipient device can be similar or identical to recipient device 164 (FIG. 1). In some embodiments, the release condition can be communicated through the computer network, from the first financial institution or from the sender device, to the system after: (a) the release condition is accepted by the sender and the recipient via the user interfaces executed on the sender device and the recipient device respectively, and (b) a transaction associated with the recipient is initiated by the sender via the user interfaces executed on the sender device. In a few embodiments, instead of obtaining the recipient account from the payment authorization, the system can be configured to determine the recipient account based on the recipient account indicator (e.g., a public key) from the payment authorization received from the first financial institution.

In several embodiments, when the payment authorization comprises the fund withholding instruction for the payment amount and associated with the release condition for the payment amount, method 200 additionally can include block 220 of the system instructing a fund withholding financial institution to post in real-time the payment amount to a fund withholding account after receiving the payment authorization. The fund withholding financial institution can be similar or identical to fund withholding financial institution 120 (FIG. 1). The fund withholding account can be similar or identical to fund withholding account 121 (FIG. 1). The fund withholding account can be different from the recipient account specified in the payment authorization, and thus while posted to the fund withholding account, the payment amount cannot be accessible to the recipient.

In a number of embodiments, method 200 further can include block 230 of the system receiving, through the computer network, a release decision from the first financial institution. In some embodiments, method 200 further can include block 240 of the system determining what the next block to execute is based on the release decision. In several embodiments, method 200 also can include block 242 of the system instructing the fund withholding financial institution to act, when the release decision is not to release the payment amount to the recipient (NOT RELEASE). In some embodiments, upon receiving such NOT RELEASE instruction, the fund withholding financial institution can cancel or un-post the payment amount from the fund withholding account.

In a number of embodiments, method 200 further can include block 250 of having the payment amount released in real-time to the recipient after the system receives the release decision to release the payment amount to the recipient (RELEASE). In several embodiments, block 250 further can include block 252 of the system instructing the fund withholding financial institution to debit in real time the payment amount from the fund withholding account after receiving the release decision. In some embodiments, block 250 also can include block 254 of the system instructing the second financial institution to post in real time the payment amount to the recipient account after the payment amount is debited from the fund withholding account.

In some embodiments, the payment amount can be posted to the recipient account by the second financial institution before, after, or at the same time when a fund settlement of the payment amount occurs between the first financial institution and the fund withholding financial institution. In certain embodiments, the fund settlement can involve transferring the payment amount debited from the sender account maintained by the first financial institution to the fund withholding account maintained by the fund withholding financial institution.

In several embodiments, the system can instruct the fund withholding financial institution and/or the second financial institution in block 220, block 242, block 252, and/or block 254 through a fund settling entity. The fund settling entity can be similar or identical to fund settling entity 170 (FIG. 1). In some embodiments, the fund settling entity can be further configured to facilitate a fund settlement of the payment amount between the first financial institution and the fund withholding financial institution.

In a number of embodiments, method 200 further can include one or more additional activities, such as the system sending, in real-time and through the computer network, a payment confirmation to the first financial institution after receiving confirmation from the second financial institution that the payment amount is posted to the recipient account, and/or the system, the first financial institution, or the second financial institution notifying the sender and/or the recipient that the payment transaction is successful or fails. In some embodiments, the sender account and the recipient account can be both maintained by the same bank (i.e., the first financial institution can be the second financial institution). In these and other embodiments, one or more of the procedures, the processes, and/or the activities in the aforementioned blocks in method 200, such as block 254, can be skipped.

Turning ahead in the drawings, FIG. 3 illustrates a flow chart for a method 300, according to an embodiment. In some embodiments, method 300 can be a method of preventing fraud in real-time payment transactions. Method 300 is merely exemplary and is not limited to the embodiments presented herein. Method 300 can be employed in many different embodiments or examples not specifically depicted or described herein. In some embodiments, the procedures, the processes, and/or the activities of method 300 can be performed in the order presented. In other embodiments, the steps, the procedures, the processes, and/or the activities of method 300 can be performed in any suitable order. In still other embodiments, one or more of the procedures, the processes, and/or the activities of method 300 can be combined or skipped. In some embodiments, method 300 can be performed by one or more of system 100 (FIG. 1) and/or system 110 (FIG. 1).

Referring to FIG. 3, method 300 can include a step 310 of a sender, via a user interface executed on a sender device, authorizing, through a computer network, a payment with a release condition to a first financial institution. The sender can be similar or identical to sender 161 (FIG. 1). The sender device can be similar or identical to sender device 162 (FIG. 1). The first financial institution can be similar or identical to first financial institution 130 (FIG. 1). The computer network can be similar or identical to network 140 (FIG. 1). The payment terms including the payment amount and the release condition can be negotiated and accepted by the sender and a recipient of the payment. The negotiation and acceptance can be performed via one or more user interfaces executed on the sender device and a recipient device respectively. The one or more user interfaces can be provided by a system, the first financial institution, and/or a fund withholding & second financial institution. The recipient can be similar or identical to recipient 163 (FIG. 1). The recipient device can be similar or identical to recipient device 164 (FIG. 1). The system can be similar or identical to system 110 (FIG. 1). The fund withholding & second financial institution can be similar or identical to fund withholding & second financial institution 180 (FIG. 1).

In some embodiments, method 300 further can include a step 320 of matching the recipient of the payment. In many embodiments, the matching can be implemented by (a) the first financial institution submitting, in real-time and through the computer network, a request comprising a recipient account identifier (e.g., a recipient public key) from a payment instruction from the sender, to the system after receiving the payment instruction from the sender device; and by (b) the system confirming in real-time that the recipient account indicator is associated with a recipient account (i.e., an account number of the recipient) known to the system after receiving the request from the first financial institution. In many embodiments, step 320 further can include determining, by the first financial institution, whether the recipient account associated with the recipient is maintained by the first financial institution before submitting the request to the system. In similar or other embodiments, when the recipient account is maintained by the first financial institution, the first financial institution can skip submitting the request to the system in step 320 and process one or more of the remaining steps, such as steps 350, 360, 370, 372, 374, and/or 380, of the payment transaction internally.

In a few embodiments, method 300 also can include a step 322 of performing sender account verification, by the first financial institution. Step 322 can include confirming: (a) that a balance of a sender account associated with the sender is not less than a payment amount of the authorized payment plus any required fees for such transaction, if applicable, (b) whether there are one or more outstanding disputes or claims against the sender account, (c) whether there is a potential overdraw of the sender account, when a combined value of the one or more outstanding disputes or claims and the payment amount can be greater than the balance of the sender account, or (d) whether a risk of bank crimes associated with the sender account is acceptable. In a number of embodiments, method 300 also can include a step 324 of the first financial institution clearing the sender account and reserving payment for the payment amount. Step 324 can be performed in real-time after the sender account verification in step 322 passes.

In a number of embodiments, method 300 also can include a step 326 of the first financial institution sending, through the computer network, a payment authorization to the system. The payment authorization can be generated by the first financial institution based on the payment instruction from the sender and comprise information regarding one or more of the sender, the recipient, the payment amount, a promise-to-pay message, the release condition, and so forth. In some embodiments, method 300 further can include a step 330 for the system to return, in real-time and through the computer network, a message indicating that the payment authorization can be deemed successfully processed to the first financial institution after the system receives the payment authorization from the first financial institution. The first financial institution also can forward in real-time this message to the sender via the sender device after receiving the success message from the system.

In several embodiments, method 300 additionally can include a step 332 of the system sending, in real-time and through a computer network, a disperse authorization to a fund withholding & second financial institution. The disperse authorization can be generated by the system based on the payment authorization from the first financial institution. In some embodiments, the disperse authorization can be identical to the payment authorization.

In a number of embodiments, method 300 also can include a step 340 of the fund withholding & second financial institution posting in real-time the payment amount to a fund withholding account maintained by the fund withholding & second financial institution after receiving the disperse authorization. The fund withholding account can be similar or identical to fund withholding account 121 (FIG. 1). The fund withholding account can be different from the recipient account. The payment amount in the fund withholding account can be inaccessible to the recipient. In many embodiments, method 300 further can include a step 342 for the fund withholding & second financial institution to notify the system regarding the successful fund withholding. In some embodiments, method 300 also can include a step 344 of the fund withholding & second financial institution reporting, in real-time and through the computer network, to the recipient via the user interface on the recipient device that the payment amount has been successfully withheld after step 340 and/or step 342.

In some embodiments, method 300 further can include a step 350 of the first financial institution sending a release decision determined based on the release condition to the system. In a number of embodiments, the release decision can be determined, either by the first financial institution or by or from the sender (and forwarded to the first financial institution). In many embodiments, method 300 also can include a step 360 of the system sending, in real-time and through the computer network, a fund release authorization, that is generated by the system based on the release decision, to the fund withholding & second financial institution after the system receives the release decision.

In a number of embodiments, method 300 additionally can include a step 370 of the fund withholding & second financial institution releasing a fund that can be the payment amount less one or more fees, if any, by transferring in real-time the fund from the fund withholding account to the recipient account after receiving the fund release authorization. In a number of embodiments, method 300 additionally can include a step 372 of the fund withholding & second financial institution notifying the system regarding the payment amount successfully transferred from the fund withholding account to the recipient account. In a few embodiments, method 300 also can include a step 374 of the fund withholding & second financial institution notifying the recipient regarding the payment amount having been released to the recipient account. In many embodiments, method 300 also can include a step 380 of the system reporting to the first financial institution that the payment amount has been released.

In several embodiments, method 300 further can include one or more additional steps. For example, in a number of embodiments, when the releasing authorization is not to release the payment amount because the release condition is not satisfied, method 300 can include a step of the fund withholding & second financial institution cancelling or un-posting in real-time the payment amount from the fund withholding account after receiving the releasing authorization. In another example, method 300 can include having a fund settling entity (e.g., fund settling entity 170 (FIG. 1)) transfer the payment amount from the first financial institution to the fund withholding & second financial institution (as well as distributing fees, if applicable) for fund settlement. The fund settlement can be performed as early as immediately after the first financial institution sends the payment authorization (e.g., in step 326), as late as days or weeks after the recipient receives the notice about the payment amount being released (e.g., in step 374), or any time in between. The fund settlement can be initiated by the system, the first financial institution, the fund settling entity, or the fund withholding & second financial institution. In yet another example, method 300 can include a step of the first financial institution charging a fee from the sender account before sending the payment authorization (e.g., in step 326) or a step of the fund withholding & second financial institution charging another fee from the recipient account before posting the payment amount to the fund withholding account (e.g., in step 340).

Turning ahead in the drawings, FIG. 4 illustrates a flow chart for a method 400, according to an embodiment. In some embodiments, method 400 can be a method of preventing fraud in real-time payment transactions. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the steps, the procedures, the processes, and/or the activities of method 400 can be performed in any suitable order. In still other embodiments, one or more of the procedures, the processes, and/or the activities of method 400 can be combined or skipped. In some embodiments, method 400 can be performed by one or more of system 100 (FIG. 1) and/or system 110. In many embodiments, method 400 can comprise one or more steps identical or similar to one or more steps of method 300, such as steps 310, 320, 322, 324, 326, and/or 330 (FIG. 3).

Referring to FIG. 4, method 400 can include steps 310, 320, 322, 324, 336, and 330 (FIG. 3). In many embodiments, method 400 further can include a step 410 of the system sending, in real-time and through a computer network, a disperse authorization to a fund settling entity, after the system receives the payment authorization (e.g., in step 326 (FIG. 3)). The system can be similar or identical to system 100 (FIG. 1) and/or system 110 (FIG. 1). The fund settling entity can be similar or identical to fund settling entity 170 (FIG. 1). Similar to the payment authorization in method 300, the payment authorization here can comprise information regarding one or more of the sender, the recipient, the payment amount, the promise-to-pay message, the release condition, and so forth. The disperse authorization can be generated by the system based on the payment authorization received from the first financial institution (e.g., in step 326 (FIG. 3)). In some embodiments, the disperse authorization can be identical to the payment authorization.

In some embodiments, method 400 further can include a step 420 of relaying the disperse authorization by the fund settling entity to a fund withholding & second financial institution that maintains the fund withholding account and a recipient account that can be determined by the system (e.g., in step 320 (FIG. 3)). The fund withholding & second financial institution can be similar or identical to fund withholding & second financial institution 180 (FIG. 1). The fund withholding account can be similar or identical to fund withholding account 121 (FIG. 1).

In a number of embodiments, method 400 also can include a step 430 of the fund withholding & second financial institution posting in real-time the payment amount to the fund withholding account after receiving the disperse authorization from the fund settling entity. The fund withholding account can be different from the recipient account. The payment amount in the fund withholding account can be inaccessible to the recipient. In many embodiments, method 400 also can include a step 432 of the fund withholding & second financial institution returning, in real-time and through the computer system, a success status of step 430 to the system after the payment amount is posted to the fund withholding account. In some embodiments, method 400 further can include a step 440 for the system to notify the recipient, via a user interface executed on the recipient device, regarding the successful fund withholding.

In some embodiments, method 400 further can include a step 450 of the fund withholding & second financial institution (a) determining a release decision based on the release condition and (b) releasing in real-time the payment amount from the fund withholding account to the recipient account after determining that the release decision is to release fund to the recipient. In a number of embodiments, step 450 can comprise one or more activities similar to those in steps 350, 360, and/or 370 (FIG. 3), in which the fund withholding & second financial institution can determine the release decision based on release condition.

In a number of embodiments, method 400 additionally can include a step 452 of the fund withholding & second financial institution notifying in real-time the system regarding the release of the fund to the recipient, including the payment amount released to the recipient, after the fund is transferred from the fund withholding account to the recipient account. In a few embodiments, method 400 also can include a step 460 of the system notifying in real-time the first financial institution regarding the payment amount released to the recipient, after the fund withholding & second financial institution confirms that the payment amount is released. In some embodiments, method 400 further can include a step 462 of notifying in real-time the recipient, by the system or the fund withholding & second financial institution, regarding the payment amount released, after the payment amount is transferred to the recipient account. Step 462 can be performed before, after, or concurrently with step 460.

In many embodiments, method 400 also can include a step 470 of the first financial institution transferring the payment amount debited from the sender account (plus any fees required by one or more of the system, the fund settling entity, or the fund withholding & second financial institution) to the fund settling entity. In several embodiments, method 400 additionally can include a step 480 of the fund settling entity transferring the payment amount to the fund withholding & second financial institution (as well as distributing the fees, if applicable) for fund settlement. The fund settlement can be performed as early as immediately after the first financial institution sends the payment authorization (e.g., in step 326 (FIG. 3)), as late as days or weeks after the recipient receives the notice about the payment amount being released (e.g., in step 462), or any time in between. The fund settlement can be initiated by the system, the first financial institution, the fund settling entity, or the fund withholding & second financial institution.

Turning ahead in the drawings, FIG. 5 illustrates a computer 500, all of which or a portion of which can be suitable for implementing an embodiment of at least a portion of system 110 (FIG. 1), fund withholding financial institution 120 (FIG. 1), first financial institution 130 (FIG. 1), second financial institution 150 (FIG. 1), sender device 162 (FIG. 1), recipient deice 164 (FIG. 1), fund settling entity 170 (FIG. 1), fund withholding & second financial institution 180 (FIG. 1), and/or the techniques described in method 200 (FIG. 2), method 300 (FIG. 3), and/or method 400 (FIG. 4). Computer 500 includes a chassis 502 containing one or more circuit boards (not shown), a USB (universal serial bus) port 512, a Compact Disc Read-Only Memory (CD-ROM) and/or Digital Video Disc (DVD) drive 516, and a hard drive 514. A representative block diagram of the elements included on the circuit boards inside chassis 502 is shown in FIG. 6. A central processing unit (CPU) 610 in FIG. 6 is coupled to a system bus 614 in FIG. 6. In various embodiments, the architecture of CPU 510 can be compliant with any of a variety of commercially distributed architecture families.

Continuing with FIG. 6, system bus 614 also is coupled to memory 608 that includes both read only memory (ROM) and random access memory (RAM). Non-volatile portions of memory storage unit 608 or the ROM can be encoded with a boot code sequence suitable for restoring computer 500 (FIG. 5) to a functional state after a system reset. In addition, memory 608 can include microcode such as a Basic Input-Output System (BIOS). In some examples, the one or more memory storage units of the various embodiments disclosed herein can comprise memory storage unit 608, a USB-equipped electronic device, such as, an external memory storage unit (not shown) coupled to universal serial bus (USB) port 512 (FIGS. 5-6), hard drive 514 (FIGS. 5-6), and/or CD-ROM or DVD drive 516 (FIGS. 5-6). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 610.

In the depicted embodiment of FIG. 6, various I/O devices such as a disk controller 604, a graphics adapter 624, a video controller 602, a keyboard adapter 626, a mouse adapter 606, a network adapter 620, and other I/O devices 622 can be coupled to system bus 614. Keyboard adapter 626 and mouse adapter 606 are coupled to a keyboard 504 (FIGS. 4-5) and a mouse 410 (FIGS. 4-5), respectively, of computer 400 (FIG. 4). While graphics adapter 524 and video controller 502 are indicated as distinct units in FIG. 5, video controller 502 can be integrated into graphics adapter 524, or vice versa in other embodiments. Video controller 502 is suitable for refreshing a monitor 406 (FIGS. 4-5) to display images on a screen 408 (FIG. 4) of computer 400 (FIG. 4). Disk controller 504 can control hard drive 414 (FIGS. 4-5), USB port 412 (FIGS. 4-5), and CD-ROM or DVD drive 416 (FIGS. 4-5). In other embodiments, distinct units can be used to control each of these devices separately.

In some embodiments, network adapter 620 can comprise and/or be implemented as a WNIC (wireless network interface controller) card (not shown) plugged or coupled to an expansion port (not shown) in computer system 500 (FIG. 5). In other embodiments, the WNIC card can be a wireless network card built into computer system 500 (FIG. 5). A wireless network adapter can be built into computer system 500 (FIG. 5) by having wireless communication capabilities integrated into the motherboard chipset (not shown), or implemented via one or more dedicated wireless communication chips (not shown), connected through a PCI (peripheral component interconnector) or a PCI express bus of computer system 500 (FIG. 5) or USB port 512 (FIG. 5). In other embodiments, network adapter 620 can comprise and/or be implemented as a wired network interface controller card (not shown).

Although many other components of computer 500 (FIG. 5) are not shown, such components and their interconnection are well known to those of ordinary skill in the art. Accordingly, further details concerning the construction and composition of computer 500 and the circuit boards inside chassis 502 (FIG. 5) need not be discussed herein.

When computer 500 in FIG. 5 is running, program instructions stored on a USB drive in USB port 512, on a CD-ROM or DVD in CD-ROM and/or DVD drive 516 (FIG. 5), on hard drive 514 (FIG. 5), or in memory 608 (FIG. 6) are executed by CPU 610 (FIG. 6). A portion of the program instructions, stored on these devices, can be suitable for carrying out all or at least part of the techniques described herein. In various embodiments, computer 500 (FIG. 5) can be reprogrammed with one or more modules, applications, and/or databases to convert a general purpose computer to a special purpose computer.

Although computer system 500 is illustrated as a desktop computer in FIG. 5, there can be examples where computer system 500 may take a different form factor while still having functional elements similar to those described for computer system 500. In some embodiments, computer system 500 may comprise a single computer, a single server, or a cluster or collection of computers or servers, or a cloud of computers or servers. Typically, a cluster or collection of servers can be used when the demand on computer system 500 exceeds the reasonable capability of a single server or computer. In certain embodiments, computer system 500 may comprise a portable computer, such as a laptop computer. In certain other embodiments, computer system 500 may comprise a mobile device, such as a smartphone. For example, sender device 162 (FIG. 1) or recipient device 164 (FIG. 1) can be a mobile device, such as a smartphone. In certain additional embodiments, computer system 500 may comprise an embedded system.

Although secure real-time payment transactions have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIGS. 2-4 may include different procedures, processes, and/or activities and be performed by many different systems, subsystems, or modules, in many different orders. One or more of the procedures, processes, or activities of FIGS. 2-4 may include one or more of the procedures, processes, or activities of another different one of FIGS. 2-4.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to run on the one or more processors and perform:
receiving, in real-time and through a computer network, a payment authorization from a first financial institution, wherein:
the payment authorization comprises a payment amount, a recipient account indicator, and a fund withholding instruction for the payment amount and associated with a release condition for the payment amount;
after receiving the payment authorization, instructing, through the computer network, a fund withholding financial institution to post in real-time the payment amount to a fund withholding account maintained by the fund withholding financial institution, wherein:
the fund withholding account is different from a recipient account;
the recipient account is maintained by a second financial institution and is associated with the recipient account indicator and a recipient; and
while posted to the fund withholding account, the payment amount is not accessible to the recipient;
receiving, through the computer network and from the first financial institution, a release decision, wherein the release decision is based on the release condition; and
when the release decision is to release the payment amount to the recipient:
instructing, through the computer network, the fund withholding financial institution to debit in real-time the payment amount from the fund withholding account after receiving the release decision; and
instructing, through the computer network, the second financial institution to post in real-time the payment amount to the recipient account after the payment amount is debited from the fund withholding account.

2. The system in claim 1, wherein:
the second financial institution comprises the fund withholding financial institution.

3. The system in claim 1, wherein:
the release condition comprises at least one of:
a predefined period of time has elapsed after the payment authorization is sent by the first financial institution or is received by the system;
a predefined point in time has passed; or
a fund release instruction is received from a sender device.

4. The system in claim 1, wherein:
the payment authorization from the first financial institution involves a promise-to-pay message by the first financial institution after successful sender account verification for the payment amount.

5. The system in claim 4, wherein:
the successful sender account verification comprises at least one of:
a lack of one or more outstanding disputes or claims against the sender account;
a lack of a potential overdraw of the sender account, wherein the potential overdraw exists when a combined value of (a) the one or more outstanding disputes or claims and (b) the payment amount is greater than a balance of the sender account; or
a low risk of bank crimes associated with the sender account.

6. The system in claim 1, wherein:
the release condition is negotiated by a sender and the recipient through the computer network via user interfaces executed on a sender device and a recipient device respectively; and
the release condition is communicated through the computer network to the system after:
(a) the release condition is accepted by the sender and the recipient via the user interfaces executed on the sender device and the recipient device, respectively, and
(b) a transaction associated with the recipient is initiated by the sender via the user interfaces executed on the sender device.

7. The system in claim 1, wherein:
the payment amount is posted to the fund withholding account by the fund withholding financial institution before a fund settlement of the payment amount occurs between the first financial institution and the fund withholding financial institution.

8. The system in claim 7, wherein:
the fund settlement involves transferring the payment amount debited from a sender account maintained by the first financial institution to the fund withholding account maintained by the fund withholding financial institution.

9. The system in claim 1, wherein:
instructing the fund withholding financial institution to post in real-time the payment amount comprises sending a fund withholding authorization to the fund withholding financial institution via a fund settling entity; and
the fund settling entity is further configured to facilitate a fund settlement of the payment amount between the first financial institution and the fund withholding financial institution.

10. The system in claim 1, wherein:
the computing instructions are further configured to run on the one or more processors and perform determining the recipient account from the payment authorization based on the recipient account indicator being a recipient public key.

11. A method being implemented via execution of computing instructions configured to run at one or more processors and stored at one or more non-transitory computer-readable media, the method comprising:
receiving, in real-time and through a computer network, a payment authorization from a first financial institution, wherein:
the payment authorization comprises a payment amount, a recipient account indicator, and a fund withholding instruction for the payment amount and associated with a release condition for the payment amount;
after receiving the payment authorization, instructing, through the computer network, a fund withholding financial institution to post in real-time the payment amount to a fund withholding account maintained by the fund withholding financial institution, wherein:
the fund withholding account is different from a recipient account;
the recipient account is maintained by a second financial institution and is associated with the recipient account indicator and a recipient; and
while posted to the fund withholding account, the payment amount is not accessible to the recipient;
receiving, through the computer network and from the first financial institution, a release decision, wherein the release decision is based on the release condition; and
when the release decision is to release the payment amount to the recipient:
instructing, through the computer network, the fund withholding financial institution to debit in real-time the payment amount from the fund withholding account after receiving the release decision; and
instructing, through the computer network, the second financial institution to post in real-time the payment amount to the recipient account after the payment amount is debited from the fund withholding account.

12. The method in claim 11, wherein:
the second financial institution comprises the fund withholding financial institution.

13. The method in claim 11, wherein:
the release condition comprises at least one of:
a predefined period of time after the payment authorization is sent by the first financial institution or is received by the system;
a predefined point in time has passed; or
a fund release instruction is received from a sender device.

14. The method in claim 11, wherein:
the payment authorization from the first financial institution involves a promise-to-pay message by the first financial institution after successful sender account verification for the payment amount.

15. The method in claim 14, wherein:
the successful sender account verification comprises at least one of:
a lack of one or more outstanding disputes or claims against the sender account;
a lack of a potential overdraw of the sender account, wherein the potential overdraw exists when a combined value of (a) the one or more outstanding disputes or claims and (b) the payment amount is greater than a balance of the sender account; or
a low risk of bank crimes associated with the sender account.

16. The method in claim 11, wherein:
the release condition is negotiated by a sender and the recipient through the computer network via user interfaces executed on a sender device and a recipient device respectively; and
the release condition is received through the computer network after: (a) the release condition is accepted by the sender and the recipient via the user interfaces executed on the sender device and the recipient device respectively, and (b) a transaction associated with the recipient is initiated by the sender via the user interfaces executed on the sender device.

17. The method in claim 11, wherein:
the payment amount is posted to the fund withholding account by the fund withholding financial institution before a fund settlement of the payment amount occurs between the first financial institution and the fund withholding financial institution.

18. The method in claim 1, wherein:
the fund settlement involves transferring the payment amount debited from a sender account maintained by the first financial institution to the fund withholding account maintained by the fund withholding financial institution.

19. The method in claim 11, wherein:
instructing the fund withholding financial institution to post in real-time the payment amount comprises sending a fund withholding authorization to the fund withholding financial institution via a fund settling entity; and
the fund settling entity is further configured to facilitate a fund settlement of the payment amount between the first financial institution and the fund withholding financial institution.

20. The method in claim 11 further comprising:
determining the recipient account from the payment authorization based on the recipient account indicator being a recipient public key.
